(19) United States
(12) Patent Application Publication
(10) Pub. No.: US 2015/0166691 A1
(43) Pub. Date: Jun. 18, 2015

(54) HYDROLYSABLE POLYCARBOXYLATE ESTERS

(71) Applicant: Sika Technology AG, Baar (CH)

(72) Inventors: Robert Flatt, Feldmeilen (CH); Christina Hampel, Rutihof (CH); Lukas Frunz, Dietlikon (CH)

(21) Appl. No.: 14/405,641

(22) PCT Filed: Jun. 5, 2013
(86) PCT No.: PCT/EP2013/061578

§ 371 Date: Dec. 4, 2014

(30) Foreign Application Priority Data
Jun. 6, 2012 (EP) 12170936.4

(51) Int. Cl. C08F 8/12; C04B 24/26; C08F 8/14

(52) U.S. Cl. CPC C08F 8/12; C08F 8/14; C04B 24/2641; C04B 2103/0045

(57) ABSTRACT

The invention relates to a method for producing an additive for a hydraulically setting composition, comprising the following steps:
(a) providing an aqueous solution containing at least one comb polymer, and
(b) cleaving side chains of the comb polymers.

The invention also relates to additives for the hydraulically setting compositions, to uses, selection methods and kits.

The invention relates to additives for hydraulically setting compositions and methods for producing them. The invention also relates to uses, kits and further methods relating to such additives.

### PRIOR ART

Comb polymers are used in concrete and gypsum technology as additives, especially as dispersants and plasticizers. By adding such polymers to hydraulically setting compositions, such as cement or gypsum, for example, the water content can be reduced without compromising the workability, which is advantageous for the stability of the cured concrete or gypsum. In addition, the workability per se can be improved at the same or lower water content. Comb polymers consist of a base polymer (“backbone,” “polymer backbone”), to which a number of side chains are covalently bonded, so that the overall molecular structure resembles a comb. There are a number of such comb polymers, which in addition to ester groups and free carboxy groups may also contain amide groups. Comb polymers that are used as additives for cement and gypsum compositions often contain polyether side chains linked via ester groups with a polycarboxylic acid base polymer.

In view of global construction activity, there is a substantial need for additives based on such comb polymers in the processing of hydraulically setting compositions, such as cement and gypsum. However, comb polymers are relatively complex in structure and tedious to synthesize. Furthermore, it is a challenge to supply comb polymers for various requirements in the global production of concrete and gypsum. That is attributable to the various types of local climates, cements, mineral constituents, aggregates, substitute cement fillers etc., as well as the various products, such as ready-mix, transport, or shotcrete; self-compacting concrete or concrete mixed on site, or various gypsum types. Therefore, a number of special additives that are effective under completely differing conditions must be made available. This means that from a plurality of comb polymer-based additives the user must select one that is suitable or optimal for a certain application. The user on a construction site will generally purchase such additives from the manufacturer, test them, and if suitable, order larger amounts. Alternatively, they must keep a number of different additives available. The selection of suitable and optimized additives for certain applications is therefore time-consuming and expensive, and regularly leads to the use of non-optimal additives. Therefore, there is a need for additives that can be used as generally as possible and under various requirements as dispersants, especially as plasticizers, for hydraulically setting compositions.

EP 1 136 508 A1 discloses comb polymer-based additives for cement compositions, wherein the comb polymers contain ester groups that hydrolyze at least partially in the alkaline cement.

US 2012/041103 A1 discloses super-plasticizers that undergo hydrolysis after mixing with alkaline cements and thus change properties. However, it is not disclosed to adjust the structure of the plasticizers by cleaving side chains already before mixing with the cements.

EP 1 061 089 A1 discloses neutralizing comb polymers before mixing them with cement. However, only small amounts of dilute sodium hydroxide are used in a neutralization of this type, so that no hydrolysis of the comb polymer occurs.

Likewise, Shengua et al., Polymers for Advanced Technologies, 9 Feb. 2012, DOI: 10.1002/pat.3034 discloses neutralizing comb polymers with dilute sodium hydroxide before mixing with cement.

### OBJECT OF THE INVENTION

The objective of the invention is to overcome the drawbacks described above. According to the invention, additives for hydraulically setting compositions are to be provided, which also achieve optimal effects in various applications. The additives are especially intended to be used as dispersants and as plasticizers and to control the setting behavior. The invention is also intended to provide methods and uses that allow a user the simplest and most effective possible use of comb polymers as additives. In this way, time and cost savings will be achieved for the user.

### DISCLOSURE OF THE INVENTION

Surprisingly, the objective of the invention will be achieved by methods, additives, uses and kits according to the claims. Further advantageous embodiments will be apparent from the description.

The subject matter of the invention is a method for producing an additive for a hydraulically setting composition, comprising the following steps:
(a) providing an aqueous solution containing at least one comb polymer, and
(b) cleaving side chains of the comb polymer.

The term “hydraulically setting composition” refers to compositions that contain hydraulically setting binders. Such binders are generally of a mineral type and cure in the presence of water. In this process the water is absorbed by the binder, especially in the form of water of crystallization. Preferred hydraulically setting compositions are cement or gypsum.

The term “additive” refers to a composition that modifies at least one property of the hydraulically setting composition during or after mixing with a hydraulically setting composition. Preferably, the additive is a dispersant. This means that the additive modifies, specifically improves the mixing of the hydraulically setting composition. Preferably, the additive or the dispersant modifies the setting behavior of the hydraulically setting composition and especially acts as a plasticizer.

In producing the additive according to the invention, the cleavage of side chains in step (b) takes place before addition to the hydraulically setting composition. The cleavage of the side chains, therefore, is not a result of mixing with the hydraulically setting composition.

According to the invention, a comb polymer in aqueous solution can be easily and quickly modified by cleavage of side chains and the solution then can be used directly as an additive for hydraulically setting compositions. In a preferred embodiment of the invention, no separation of components from the aqueous solution takes place after cleavage of the side chains and before use as an additive for a hydraulically setting composition. According to the invention, the additive is obtained in step (b) after cleaving side chains of a comb polymer in an aqueous solution of the comb polymer. In a particularly preferred embodiment, the additive is the direct product of step (b), i.e., the aqueous solution containing at least one comb polymer after cleaving side chains of the comb polymer. Then, the additive can be added unchanged to a hydraulically setting composition. According to the invention it is therefore preferred for the aqueous solution obtained in step (b) and/or the modified comb polymer not to be further purified, and/or for the comb polymer not to be chemically modified in subsequent steps. In this way, the method according to the invention differs distinctly from methods for the synthesis of comb polymers in which side chains may be cleaved in intermediate steps, however, yielding a reaction mixture in which the comb polymer must still be purified, or in which undesired components, such as catalysts and starting materials for the synthesis of the comb polymers must still be removed, the solution must be concentrated, the comb polymer must be converted into the salt, etc. Preferably, cleaving the side chains in step (b) and the incorporation into the hydraulically setting composition are performed by the same user from the construction industry. Accordingly, preferably, step (b) is not performed by the manufacturer of the comb polymer.

According to the invention, an additive is obtained which has a comb polymer with partially cleaved side chains and that is, or can be used for a construction application. In the construction application, a cured shaped article is produced, which is not used for testing purposes. Rather, the shaped article is the actual construction target, for example a building or a component thereof, a floor covering, a coating, a filling or a construction element, such as a concrete plate. It is known in the prior art and from EP 1 136 508 A1 that ester group-containing comb polymers partially hydrolyze in alkaline cement compositions with cleavage of side chains. The invention distinguishes itself from EP 1 136 508 A1 in that the cleavage of side chains takes place in order to produce an additive and thus before mixing with a cement. According to the invention, the additive with partially cleaved side chains is used in construction applications. By contrast, according to EP 1 136 508 A1, no method is disclosed in which a comb polymer with partially cleaved side chains is used in a construction application, rather merely a test is conducted of whether a comb polymer hydrolyzes in a cement composition. According to the invention, cleaving the side chains in step (b) does not take place with the hydraulically setting composition itself, and preferably also not with a fraction thereof, such as filtered cement water. Regardless, even with the additive according to the invention, cleaving any side chains still present can occur in the hydraulically setting composition.

The method of the invention can be performed to produce an additive for a construction application. The method can also be performed as a test method to select, improve or optimize an additive for a hydraulically setting composition for a later construction application.

In a preferred embodiment of the invention the production and/or selection of the additive is performed for testing purposes, and subsequently the additive produced and/or selected is used in a construction application. Optionally, the production of the additive in a quantity required for the application takes place before use.

Cleaving the side chains in step (b) is performed in a targeted manner. This means that cleaving is not just a minor secondary reaction of another method, for example the neutralization of a comb polymer with a base. Preferably, a significant portion of the side chains is cleaved, for example, at least 1%, at least 2%, at least 5% or at least 10% of all side chains of the comb polymer.

In a preferred embodiment of the invention, cleaving side chains results in adjustment of at least one property of a hydraulically setting composition containing the additive. In particular, the property is a physical property relating to the workability or stability after curing. In a particularly preferred embodiment of the invention this property is the dispersing power and/or the setting behavior, wherein the additive especially acts as a plasticizer.

The property may be a property of the hydraulically setting composition before setting, during setting or after setting, and thus before and after curing to form a shaped article. An important property, which is usually determined only after curing, is the mechanical stability of the shaped article. As stated above, it is known in the prior art that comb polymers act as dispersants in hydraulically setting compositions, modify the setting behavior, and particularly act as plasticizers. Thus, comb polymers modify properties of the hydraulically setting compositions, especially the workability before and during setting and/or before curing. As a result, the comb polymers also influence properties of the cured compositions, such as the mechanical stability.

The effect of the comb polymer in a hydraulically setting composition depends on the structure of the comb polymer. It is generally assumed that negatively charged base polymers bind to mineral particles and the side chains face away from the particles, wherein polyether chains especially cause a plasticizing effect. Here, the length and molecular weight of the comb polymer, the ratio of base polymer and side chains, the chemical structure and functional groups, the length, number and distribution of the side chains and the number of charges and charge distribution are important. The invention makes use of the fact that the number of side chains in the comb polymer has a significant influence on the properties of a hydraulically setting composition.

In a preferred embodiment of the invention a series of experiments is performed to identify an additive that has an optimal effect on a hydraulically setting composition. For this purpose, preferably, at least two additives according to the invention are produced, in which the side chains of the same comb polymer are cleaved to differing degrees. For the various additives in each case the effect in a hydraulically setting composition is tested and comparisons are performed to determine which additive is especially suited for achieving a desired property. Such a series of experiments may include, for example, two, three, four, five, six or more experiments. Several series of experiments may also be performed successively or in parallel to get to an additive with the most advantageous properties step by step. Here, the user can identify a suitable additive for a specific hydraulically setting composition, produced under defined conditions (such as temperature, humidity). After they have identified the additive, they can produce the same in the required quantity and perform the actual processing of the hydraulically setting composition.

In a further preferred embodiment of the invention, the production method according to the invention is performed to obtain an additive in a sufficient quantity and use it for a construction application. Here, the additive may have been found in preliminary experiments using the methods according to the invention.

However, the user can also determine, for example, using known data in the form of comparison tables, the extent to which cleaving the side chains must be performed for a given comb polymer to obtain an additive with advantageous properties. Based on the comparison tables and with regard to specific hydraulically setting compositions, by cleaving the side chains they will systematically produce an additive that is suitable for the desired application. For example, the extent of cleavage of the side chains with respect to the specific problem can be determined using a computer database. In this embodiment it is advantageous that preliminary experiments for determining a suitable or optimal comb polymer are not necessary or can be limited to a minimum.

Also, subject matter of the invention is a method for selecting an additive for a hydraulically setting composition, comprising the following steps:
(A) producing an additive according to the method according to the invention,
(B) mixing the additive with a hydraulically setting binder,
(C) setting the hydraulically setting composition by mixing with water,
(D) determining at least one property of the hydraulically setting composition, and
(E) comparing the property with the same property of at least one additional hydraulically setting composition containing a corresponding additive in which the cleavage of the side chains took place to a different extent.

The method is used for selecting a suitable additive for a specific application. It is used to prepare for the actual use of the additive in the construction field. The term “selecting” also includes identification of a particularly suitable additive and the optimization of a comb polymer or additive for a certain application, respectively. The method is preferably performed in the sequence of steps from (A) to (E), wherein steps (B) and (C) may also be performed simultaneously or in the reverse order.

In step (E) the same property of at least two samples is compared. The selection method may be conducted with a single sample or as a series of experiments with two or more samples. The samples differ with regard to the comb polymer. Preferably, the comb polymer in the various samples is the same with the exception of the side chains, which are cleaved to differing extent. Preferably, the samples are identical except for the comb polymer, or were produced in the same way except for the extent of the cleavage of the side chains. Comparing these enables the selection of the additive that is especially suitable for the hydraulically setting composition.

In a preferred embodiment of the invention, following step (E), the method includes a step
(F) determining based on the comparison which additive is suitable for use in the hydraulically setting composition.

Here it is determined which additive is advantageous considering the circumstances of the specific intended use. It may be advantageous to test several properties and balance them against one another. For example, in the case of plasticizers, in addition to the plasticizing effect, the mechanical stability of the cured shaped articles can be tested and compared. The additive that is particularly suitable for the hydraulically setting composition will be selected for later use.

The hydrolysis reaction is performed under suitable conditions. For example, the temperature can be increased to about 30 to 80° C., especially 65° C., to accelerate hydrolysis. The pH can be adjusted such that an optimal reaction is achieved.

The comb polymer used in step (a) consists of a base polymer, to which a plurality of side chains are covalently bonded, so that the overall molecular structure resembles a comb. Preferably, the base polymer is a polycarboxylic acid. Preferably, the polycarboxylic acid is a polyacrylic acid, polymethacrylic acid or a copolymer of acrylic acid and methacrylic acid.

Preferably, the side chains of the comb polymer have polyether groups, especially polyoxyethylene or polyoxypropylene groups. Preferably, the side chains in this case are polyethers, especially polyethylene glycols or polypropylene glycols, optionally substituted terminally, for example with C1 to C12 alkyl groups. The polyethers may be linked to the base polymer via ester groups, amide groups or ether groups.

Preferably, the comb polymer has side chains that are linked to the polycarboxylic acid via ester groups, wherein at least part of the side chains has polyether groups. Polyether groups should be present to a sufficient extent to ensure good dispersibility and especially a plasticizing effect in a hydraulically setting composition. In a preferred embodiment, in the comb polymer in step (a) all side chains or a substantial portion of the side chains are linked to the base polymer via ester groups. In that case, cleavage of the side chains in step (b) can be controlled especially well. The portion of side chains bound via ester groups of all side chains of the comb polymer is preferably at least 80%, at least 90%, at least 98% or preferably 100%.

The polycarboxylic acid of the comb polymer used in step (a) is usually not completely endowed with side chains and especially not completely esterified. The comb polymer then has free carboxy groups of the base polymer. When producing such comb polymers by polymer-analogous manufacturing methods, usually up to 50% of the base polymer are endowed with side chains. In the production of the comb polymers by polymerization, a higher endowment with side chains of the comb polymer can be obtained. However, free carboxy groups are advantageous for an optimal plasticizing effect. An only partial endowment of the comb polymer with side chains in step (a) therefore has the advantage that the starting comb polymer already has a moderate plasticizing effect because of the free carboxy groups.

In a preferred embodiment of the invention, the comb polymer, prior to cleaving the side chains in step (b), has a content of side chains and/or a degree of esterification of the base polymer of between 15% and 100%, especially between 20% and 99%, preferably between 30% and 95%, based on the total number of carboxy groups of the base polymer. In particular, 20% to 60% or 30% to 50% of the side chains may be present and/or may be esterified. In a preferred embodiment, the comb polymer has one of the degrees of esterification mentioned and contains no further side chains. This means that the base polymer has a corresponding portion of free carboxy groups (as acid or salt groups of the backbone).

Preferably, the comb polymer used in step (a) has free carboxy groups of the polycarboxylic acid. In this case the comb polymer may be present as a free acid or as a salt, wherein only some of the acid groups may also be present as a salt. The polycarboxylic acid is then completely or partially neutralized. Preferably, the content of free carboxy groups is between 1% and 80%, especially between 5% and 70%, based on the total number of carboxy groups in the base polymer. In particular, 40% to 80% or 50% to 70% of free carboxy groups may be present.

The production of such comb polymers is known in the prior art and can, for example, according to EP 2065403 A1 take place by acid-catalyzed esterification of polycarboxylic acids with monohydroxy-polyethers in the presence of strong mineral acids, preferably sulfuric acid.

The comb polymer used in step (a) preferably has a mean molecular weight Mₙ in the range of 6,000 to 150,000 g/mol, advantageously 10,000 to 100,000 g/mol, particularly preferably 15,000 to 80,000 g/mol.

The embodiments that follow relate to preferred structures of the comb polymer used in step (a). In a preferred embodiment of the invention, the comb polymer comprises:
a) at least one acid unit S of formula (I):

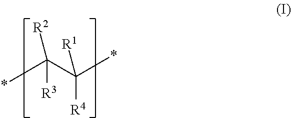

wherein each R¹, R² and R³ independently of one another represents H, —COOM, —CH₂COOM or an alkyl group having 1 to 5 carbon atoms,
each R⁴ independently of one another represents —COOM, —CH₂COOM, —SO₂—OM, —O—PO(OM)₂ and/or —PO(OM)₂;
or where R³ with R⁴ forms a ring forming —CO—O—CO—;
where M represents H, an alkali metal, an alkaline earth metal, ammonium, an ammonium cation, an organic ammonium compound or mixtures thereof;
provided that in total, a single one or two of the radicals R¹, R², R³ and R⁴ are acid groups,
   where the acid unit S especially
   is or comprises at least one acrylic acid unit A or a salt thereof and/or at least one methacrylic acid unit M or a salt thereof; and
a) at least one structural unit B of formula (I);

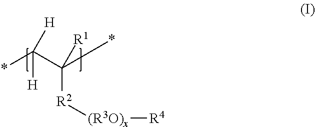

wherein
R¹ independently of one another represents H or CH₃;
R² independently of one another represents an ester group —CO—O— or an amide group —CO—NH—,
R³ independently of one another represents a C₂-C₆ alkylene group, especially an ethylene or propylene group,
R⁴ independently of one another represents H, a C₁-C₁₂ alkyl or cycloalkyl radical, a C₇-C₂₀ alkylaryl or aralkyl radical or a substituted or unsubstituted aryl radical, or a monovalent organic radical having 1 to 30 C atoms, which optionally includes hetero atoms, and
   x independently of one another is a value between 0 and 250, preferably between 3 and 200.

The acid unit S is usually introduced into the polymer in that the polymerization is performed in the presence of a corresponding acid monomer or a salt or anhydride thereof. Especially suitable acid monomers in such cases are α-unsaturated mono- or dicarboxylic acids, especially acrylic acid, methacrylic acid, maleic anhydride, maleic acid, itaconic acid, crotonic acid or fumaric acid.

Here, the main chain of the comb polymer is preferably a linear polymer or copolymer that was obtained from the acid unit S, especially the at least one acrylic acid unit A or the salt thereof and/or the at least one methacrylic acid unit M or the salt thereof by polymerization. The structural unit B is a constituent of the comb polymer. The base polymer of the comb polymer, depending on the selection of a) and b), can be a polyacrylic acid or a polymethacrylic acid or a copolymer of acrylic acid and methacrylic acid. The acid unit S, especially the at least one acrylic acid unit A, and the at least one methacrylic acid unit M, can be partially or completely neutralized. The acid unit can be present as free acid or also as a salt or partial salt or anhydride, where the term “salt” here and below, in addition to the conventional salts such as those obtained by neutralization with a base also includes complexes between metal ions and the carboxylate or carboxy groups as ligands. The conventional salts are especially obtained by neutralization with sodium hydroxide, calcium hydroxide, magnesium hydroxide, ammonium hydroxide or an amine.

The structural unit B of formula (I), depending on the selection of the radical R², may be an ester or an amide. The comb polymer contains ester groups and optionally additional amide groups. The portion of the structural units B linked via ester groups in such cases is advantageously at least 80%, at least 90% or at least 98%, particularly preferably 100%, based on the total of all structural units B. At position R², for example, the comb polymer may have a content of amide groups of 0.01 to 2%, especially between 0.02 and 0.2%, based on the total number of carboxy groups of the base polymer. In a particularly preferred embodiment no amide groups are present at position R², rather only ester groups.

In a preferred embodiment, —(R³O)ₓ— represents a C₂ to C₄ polyoxyalkylene group, especially a polyoxyethylene group or a polyoxypropylene group or mixtures of oxyethylene and oxypropylene units in any arbitrary order, for example random, alternating or blockwise. R⁴ is advantageously not H and particularly preferably it is a methyl radical.

In a preferred embodiment of the invention the comb polymer has, out of the total number of all (R³O)ₓ units, a content of ethylene oxide units of at least 30 mol-%, preferably 50 to 100 mole-%, especially 80 to 100 mole-%. In particular, the comb polymer contains exclusively ethylene oxide units as the (R³O)ₓ units.

In an embodiment of the invention, the comb polymer additionally may contain polyether side chains linked via ether groups to the base polymer.

In an embodiment of the invention, the comb polymer has at least one additional structural unit C that is different from the structural units A, B and M and is selected from an ether, ester, amide or imide unit, an acid unit selected from carboxylic acid, sulfonic acid, phosphonic acid, phosphoric acid ester, carbonylamidomethyl-propanesulfonic acid and the salts thereof, or a polyoxyalkyleneoxycarbonyl, polyoxyalkyleneaminocarbonyl, polyoxy-alkyleneoxyalkyl, polyoxyalkyleneoxy, hydroxyethyloxycarbonyl, acetoxy, phenyl or N-pyrrolidonyl group. Preferably, the additional structural unit C comprises polyoxyalkylene groups, preferably polyoxyethylene groups, polyoxypropylene groups or mixtures thereof. For example the structural unit C may be an ester unit produced by reacting a mono- or dicarboxylic acid with an alkyl alcohol, especially a C₆-C₇₀ alkyl alcohol.

The comb polymer can have a combination of various structural units from among the respective structural units A, M, B and optionally C. For example, several acid units A and M mixed which are not at all, or completely neutralized may be present in the comb polymer. Alternatively, several different ester and/or amide units B mixed may be present in the comb polymer, for example several ester units B with various substituents R³. Preferred, for example, is the joint use of polyoxyalkylenes, especially polyoxyethylene with polyoxypropylene, or the joint use of polyoxyalkylenes, especially of polyoxyethylene, having different molecular weights.

In a preferred embodiment of the invention, the comb polymer comprises
a) 5 to 70 mole-%, advantageously 40 to 70 mole-% acrylic acid units A and/or 5 to 70 mole-%, preferably 40 to 70 mole-% methacrylic acid units M, where preferably the sum of the acrylic acid units A and the methacrylic acid units M is 5 to 70 mole-%, preferably 40 to 70 mole-%,
b) 30 to 95 mole-%, preferably 30 to 60 mole-% of the structural unit B, and
c) 0 to 30 mole-%, preferably 0 to 5, and especially none of structural unit C,
   in each case based on the total number of all monomer units in the main chain of the comb polymer.

The sequence of the individual structural units A, M, B, and C in the comb polymer can be alternating, random or blockwise.

In the production of the polycarboxylic acid base polymers, the adjustment of the chain length is accomplished with a controlling agent, for example phosphite or sulfite. Therefore, the polycarboxylic acids may contain groups that are not carboxylic acid units, for example, phosphorus- or sulfur-containing groups.

The cleavage of the side chains in step (b) of the method according to the invention is preferably accomplished by alkaline hydrolysis of ester groups. In a preferred embodiment of the invention the base is a strong base, especially metal hydroxide, especially sodium or potassium hydroxide. The metal hydroxide is preferably used in aqueous solution. In a preferred embodiment the cleavage of the side chains is controlled in that the reaction is ended after a defined time period, especially by neutralization of the base. The alkaline hydrolysis of ester groups has the advantage that the reaction can be controlled well and can be ended after a defined time period simply by neutralization. In this manner, various additives, esterified to a different extent, can be produced in a simple manner in step (b). The base is selected here in such a manner that targeted cleavage of the ester groups takes place and the rest of the comb polymer is not at all or only slightly chemically modified. According to the invention, other chemical reactions can also be used in step (b) to cleave side chains and control the reaction.

In a preferred embodiment of the invention, in step (b) between 5 and 95%, especially between 10 and 90% of all side chains of the comb polymer are cleaved. It should be noted here that the advantageous action of such comb polymers in hydraulically setting compositions is generally no longer achieved if too many side chains are cleaved. Optimal properties are often obtained if a portion of the side chains is cleaved that is not too high and also not too low. Therefore, according to the invention it is preferred that in step (b) a comb polymer is obtained that still contains at least 10%, at least 20% or at least 30% side chains, based on all monomer subunits of the base polymer.

In a preferred embodiment of the invention, in step (b) a comb polymer is used in which some of the side chains are not cleavable in the aqueous solution under the selected conditions. In this way it is possible to prevent an excessive portion of the side chains of the comb polymer from being cleaved and the advantageous effect in a hydraulically setting binder from decreasing too greatly or disappearing. Preferably, up to 10%, up to 20%, up to 30%, or up to 40% of the side chains of the comb polymer, based on all monomer subunits of the base polymer, are not cleavable in step (b). In this embodiment, the comb polymer provided in step (a) contains two different types of side chains. For example, a comb polymer can be used that has side chains linked to the base polymer via alkali-hydrolyzable ester groups and also has side chains, linked via ether groups to the base polymer that cannot be cleaved under the conditions of basic hydrolysis.

An additional subject matter of the invention is a method for producing a hydraulically setting composition in which an additive produced and/or selected according to the invention is mixed with a hydraulically setting binder. In a preferred embodiment of the invention, the hydraulically setting binder is selected from the group consisting of cement, gypsum, for example in the form of an anhydrite or hemihydrate, and quicklime. The cements are, for example, Portland cements, high-alumina cements or mixtures thereof with conventional additives. Optionally, the hydraulically setting composition may contain additives. Common additives are, for example, fillers and admixtures, such as fly ashes, silica fume, slag, slag sand, limestone fillers, sand, gravel, rocks, quartz flour and chalks. For example, mixtures of cement with fly ash, silica fume, slag, slag sand or limestone filler may be used. In addition, processing aids and admixtures which influence the properties of the setting and cured compositions may be added. For example, concrete plasticizers, such as lignosulfonates, sulfonated naphthalene-formaldehyde condensates, sulfonated melamine-formaldehyde condensates or polycarboxylate ethers may be present, as well as accelerators, corrosion inhibitors, retarding agents, shrinkage reducers, defoamers, dyes or pore formers.

Preferably, the comb polymer is used in a quantity of 0.01 to 5% by weight, especially 0.05 to 2% by weight or 0.1 to 1% by weight, based on the weight of the hydraulically setting binder.

The admixture can be added to the hydraulically setting composition with or shortly before or shortly after the addition of the waters. The addition of the comb polymer in the form of an aqueous solution or dispersion, especially as mixing water or as part of the mixing water, has proven particularly suitable. In particular, the aqueous solution is produced by subsequent mixing with water. However, the comb polymer can also be added to a hydraulically setting composition before or during the grinding process thereof, for example the process of grinding cement clinker to cement.

An additional subject matter of the invention is a method for producing a shaped article, in which a hydraulically setting composition produced according to the invention is cured. According to the invention, the term “shaped article” refers to three-dimensional bodies, for example, a building or a component thereof, a floor covering, a coating, a filling or a construction element such as a concrete plate.

An additional subject matter of the invention is an additive for a hydraulically setting composition, obtainable by a method according to the invention. The additive differs from known additives in that the aqueous solution not only contains the comb polymer, but also the cleaved side chains, wherein the structure of the cleaved side chains exactly correspond to the side chains that were not cleaved from the comb polymer. Additives, such as a base or a catalyst, added for cleaving the side chains, or the reaction products thereof are likewise present. Preferably, the additive is adapted for a hydraulically setting composition. Advantageously, the additive allows for the use of the reaction products of the hydrolysis, since the cleaved polyether side chains generally enhance the plasticizing effect. Thus, the additive can be used directly as an optimized dispersant and is thus an inventive intermediate product for performing the method according to the invention.

The additive can especially be used as a plasticizer, as a water reducer, for improving the workability and/or for improving the flowability of hydraulically setting compositions. In particular, hydraulically setting compositions with prolonged workability can be obtained using the additive.

In addition to the aqueous solution of the comb polymer and the cleaved side chains, the additive can contain additional constituents, such as other plasticizers, for example lignosulfonates, sulfonated naphthalene-formaldehyde condensates, sulfonated melamine-formaldehyde condensates or additional polycarboxylate ethers (PCE), accelerators, retardants, shrinkage reducers, defoamers, air pore formers or foam formers. Typically, the content of the comb polymer amounts to 5 to 100% by weight, especially 10 to 100% by weight, based on the total dry weight of the additive. In a preferred embodiment of the invention the additive already contains components that promote or inhibit the cleavage of the side chains in step (b). For example, components may be included that are activated by temperature or pH, so that the cleavage of the side chains can be initiated in this way.

A further subject matter of the invention is the use of a base for cleaving the side chains of a comb polymer in the adjustment of at least one property of a hydraulically setting composition containing the comb polymer.

A further subject matter of the invention is a kit for producing and selecting an additive for a hydraulically setting composition, in which the kit contains an aqueous solution of a comb polymer and a base for cleaving side chains of the comb polymer, wherein additional components may also be present. The “kit” is a combination of the components. Preferably, the kit is supplied in a form such that the user can easily perform series of experiments or individual experiments to adapt an additive to a hydraulically setting composition and modify its properties in the desired manner Preferably, the components are present as aqueous solutions, for example in bottles for easy dosing. Instructions for the user are usually included as well. The instructions guide the user to perform the cleavage of side chains of the comb polymer with the base in a controlled manner and to the desired extent.

The method according to the invention achieves the object of the invention. According to the invention, a simple, rapid and efficient method is provided for producing additives for specific hydraulically setting compositions, selecting them and optimally adapting them to specific circumstances. The method can be performed by users in construction engineering, especially directly on a construction site. In this way it is not necessary for the user to buy and keep available a plurality of different comb polymers. The method according to the invention can be performed as a preliminary experiment for selecting suitable additives as well as for specifically adapting an additive to a construction engineering application.

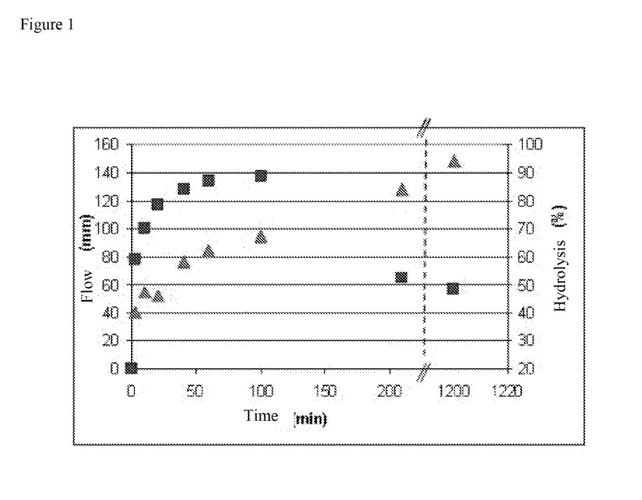

FIG. 1 presents the results of cement paste experiments 20 to 27 in graphic form. The rhombi show the hydrolysis of the side chains of a comb polymer in percent as a function of time in minutes. The squares show the flow behavior in millimeters for the same comb polymers.

### WORKING EXAMPLES

### A Preparation of the Cement Pastes and Measurement of the Slump

All of the cement pastes were produced using a mixture of three cements (brand name Normo 4 from Holcim, brand name CEM I 42.5 from Jura Cement, brand name CEM I 42.5 from Vigiers). The mixing ratio was 1:1:1. 100 g of the cement mixture is weighed out in a beaker. 32.5 g water already containing the polymer produced according to Tables 1.1 and 2.1 are added to the cement all at once. The resulting cement paste is then stirred using a spatula for one minute. After resting for an additional minute, stirring is continued for another 15 seconds. Immediately after the preparation, the slump of the paste is determined using the following procedure: a truncated cone standing on a glass plate is filled with the cement paste. Then, the truncated cone is lifted and the diameter of the resulting cement cake is measured with a slide caliper. The dimensions of the truncated cone are: diameter at bottom=38 mm, diameter at top=19 mm, height=57 mm.

### B Preparation of the Gypsum Pastes and Determining the Slump

200 g of the gypsum (β-hemihydrate of SGD Stuck brand, Spremberg Co., Germany) are weighed out in a beaker. Separately, a second beaker is charged with 136.4 g of water already containing the polymer prepared according to Tables 1.2 and 2.2. Then, the weighed-out gypsum is sprinkled into the water over a period of 15 seconds. Then, it is allowed to stand for an additional 15 seconds until the gypsum is soaked. Then, it is mixed thoroughly by hand for 30 seconds using a wire whisk. A plastic cylinder standing on a glass plate is immediately filled with the gypsum paste. The cylinder is lifted 75 seconds after the gypsum has been sprinkled into the water. The diameter of the resulting gypsum cake is measured with a slide caliper. The dimensions of the cylinder are: height=50 mm, diameter=50 mm.

### C Hydrolysis Experiments

The examples were performed with two polycarboxylate esters (polymers PCE A and PCE C). Both comb polymers were produced by polymer-analogous esterification of a polycarboxylic acid with methylpolyethylene glycol. A detailed description of this method of production was disclosed, for example, in EP 1 138 697B1 on page 7, line 20 to page 8, line 50 or in EP 1 061 089 B1 page 4, line 54 to page 5, line 38, or in the examples of the respective documents. PCE A was produced with an acrylic acid backbone. 38% of the available carboxylic acid groups are esterified (degree of esterification=38%). PCE C was produced with a mixed acrylic-methacrylic acid backbone (ratio 3:1). Likewise, the degree of esterification is 38%.

Series of hydrolysis experiments were performed with the comb polymers PCE A and PCE C in cement and gypsum. In series of experiments 1 (Examples 1 to 19) the hydrolysis of the PCE was controlled via the amount of base added. In series of experiments 2 (Examples 20 to 45) the basic composition of the sample is constant and the hydrolysis is controlled via the duration of the hydrolysis treatment.

### D Series of Experiments 1: Control of Hydrolysis Via the Amount of NaOH Added

The production of the composition according to Example 1 will be described by way of example below. All other samples were produced in the same way. The experimental conditions and results are summarized in Tables 1.1 and 1.2. Table 1.1 summarizes the results of experiments with cement pastes. Table 1.2 contains the results of the gypsum paste experiments.

### Example 1

In a beaker, 0.51 g of a solution of PCE A (40.1% dry matter content) and 5.52 g of water are mixed. Then, 2.09 g of a 0.1 N NaOH solution are added and stirred. The beaker is closed with a lid and held in an oven at 65° C. for 20 minutes. Then, the beaker is removed from the oven and 24.38 g of cold water are added. Now the beaker contains the 32.5 g of water needed for the cement paste test, including the treated polymer. This solution is used for the cement paste test immediately after preparation. The resulting slump is given in Table 1.1.

The sample from Example 5 was produced in the same way except that no NaOH solution was added; i.e., no hydrolysis occurs. The sample from Example 6 contains the same amount of polymer PCE A and water, but was not kept in the oven and contains no NaOH solution. The two examples are labeled in the tables as Comparisons (V).

A 1.0 N NaOH solution was used for preparing the sample of Example 11.

The results show that the flowability of the cement and gypsum compositions can be adjusted via the amount of base added.

TABLE 1.1
Cement paste experiments

| | | Dry | | | | Time | | | |
|---|---|---|---|---|---|---|---|---|---|
| | | matter | | | 0.1N | at | | | Cement |
| | | content | PCE | Water | NaOH | 65° C. | Water | Total | slump |
| Ex. | PCE | (%) | (g) | (g) | (g) | (min) | (g) | (g) | (mm) |
| 1 | A | 40.1 | 0.51 | 5.52 | 2.09 | 20 | 24.38 | 32.5 | 60 |
| 2 | A | 40.1 | 0.51 | 5.18 | 2.7 | 20 | 24.11 | 32.5 | 80 |
| 3 | A | 40.1 | 0.51 | 5.33 | 3.08 | 20 | 23.58 | 32.5 | 95 |
| 4 | A | 40.1 | 0.52 | 5.13 | 6.6 | 20 | 20.25 | 32.5 | 136 |
| 5 (V) | A | 40.1 | 0.51 | 6.54 | 0 | 20 | 25.45 | 32.5 | 60 |
| 6 (V) | A | 40.1 | 0.51 | 0 | 0 | 0 | 31.99 | 32.5 | 57 |
| 7 | C | 40.0 | 0.51 | 4.96 | 2.09 | 20 | 24.92 | 32.5 | 80 |
| 8 | C | 40.0 | 0.50 | 5.36 | 2.78 | 20 | 23.86 | 32.5 | 84 |
| 9 | C | 40.0 | 0.49 | 5.47 | 3.16 | 20 | 23.38 | 32.5 | 86 |
| 10 | C | 40.0 | 0.51 | 5.19 | 6.79 | 20 | 20.01 | 32.5 | 87 |
| 11 | C | 40.0 | 0.50 | 5.25 | IN: 1.06 | 20 | 25.69 | 32.5 | 105 |
| 12 (V) | C | 40.0 | 0.50 | 7.18 | 0 | 20 | 24.82 | 32.5 | 78 |
| 13 (V) | C | 40.0 | 0.49 | 0 | 0 | 0 | | 32.5 | 78 |

TABLE 1.2
Gypsum paste experiments:

| | | Dry | | | | Time | | | |
|---|---|---|---|---|---|---|---|---|---|
| | | matter | | | 0.1N | at | | | gypsum |
| | | content | PCE | Water | NaOH | 65° C. | Water | Total | slump |
| Ex. | PCE | (%) | (g) | (g) | (g) | (min) | (g) | (g) | (mm) |
| 14 | A | 40.1 | 1.00 | 10.21 | 13.11 | 20 | 112.08 | 136.4 | 169 |
| 15 | A | 40.1 | 1.01 | 9.76 | 19.90 | 20 | 105.73 | 136.4 | 172 |
| 16 | A | 40.1 | 1.01 | 8.97 | 13.02 | 40 | 113.4 | 136.4 | 180 |
| 17 | A | 40.1 | 1.01 | 10.66 | IN: 7.53 | 20 | 117.2 | 136.4 | 211 |
| 18 (V) | A | 40.1 | 1.01 | 10.01 | 0 | 20 | 125.38 | 136.4 | 163 |
| 19 (V) | A | 40.1 | 1.00 | 0 | 0 | 0 | 135.4 | 136.4 | 164 |

### E Series of Experiments 2: Control of Hydrolysis Over the Duration of Treatment

The experimental conditions and results are summarized in Tables 2.1 and 2.2. Table 2.1 summarizes the results of experiments with cement pastes. Table 2.2 contains the results of the gypsum paste experiments.

The production of the sample of Example 20 will be described by way of example below. The other samples were produced in the same way except that the duration of treatment varied. First, a stock solution S1 is produced. For this purpose, 5.0 g of a solution of PCE A (40.1% solids content) and 5.254 g of water are mixed in a beaker. Then, 25.0 g of a 1.0 N NaOH solution are added and mixed well. This stock solution is covered to prevent evaporation and stored at 22° C. The sample according to Example 20 was prepared by transferring 4.00 g of the stock solution into a separate beaker after 3 minutes. One drop of a phenolphthalein solution is added to this as a pH indicator. The solution turns pink. Then, the amount of 0.1 N HCl solution needed for complete discoloration is added. Subsequently, 2.90 g of water are added. The total mass of the sample from Example 20 is now 32.5 g.

This solution is used for the cement test immediately after it has been prepared. The results of the cement tests are summarized in Table 2.1. The sample from Example 28 contains the same quantities of PCE A, 0.1 N HCl and water, but was not subjected to a hydrolysis treatment. The degree of hydrolysis was determined for examples 20 to 27, i.e., the ratio of the number of side chains cleaved to the total number side chains in the initial polymer. In this process, the number of side chains was determined by titrating the acid with 0.1N NaOH.

TABLE 2.1
Cement paste experiments:

| Stock | | Solids content | Quantity | | |
|---|---|---|---|---|---|
| solution | PCE | (%) | (g) | Water (g) | 1N NaOH (g) |
| S1 | A | 40.1 | 5.00 | 5.254 | 25.00 |

| | Hydrolysis | | | | | | Degree of |
|---|---|---|---|---|---|---|---|
| | 22° C. | Quantity | 0.1N | Water | | | hydrolysis |
| Ex. | [min] | of S1 (g) | HCl (g) | (g) | Total (g) | Slump (mm) | (%) |
| 20 | 3 | 4.00 | 25.60 | 2.90 | 32.5 | 78 | 40 |
| 21 | 10 | 4.00 | 25.47 | 3.03 | 32.5 | 100 | 47 |
| 22 | 20 | 4.08 | 26.00 | 2.42 | 32.5 | 117 | 46 |
| 23 | 40 | 4.03 | 25.45 | 3.02 | 32.5 | 128 | 58 |
| 24 | 60 | 4.00 | 25.19 | 3.31 | 32.5 | 134 | 62 |
| 25 | 100 | 4.07 | 25.53 | 2.90 | 32.5 | 137 | 67 |
| 26 | 210 | 4.02 | 24.90 | 3.58 | 32.5 | 65 | 84 |
| 27 | 1200 | 4.01 | 24.65 | 3.84 | 32.5 | 57 | 94 |
| 28 (V) | 0 | A: 0.55 | 24.23 | 7.72 | 32.5 | 55 | 0 |

| Stock | | Solids content | Quantity | | |
|---|---|---|---|---|---|
| solution | PCE | (%) | (g) | Water (g) | 1N NaOH (g) |
| S2 | C | 40 | 10.0 | 10.08 | 50.16 |

| | Hydrolysis | | | | | |
|---|---|---|---|---|---|---|
| | 22° C. | Quantity von | 0.1N HCl | | | Slump |
| Sample | [min] | S2 (g) | (g) | Water (g) | Total (g) | (mm) |
| 29 | 3 | 4.00 | 25.3 | 3.2 | 32.5 | 112 |
| 30 | 17 | 3.99 | 25.2 | 3.31 | 32.5 | 128 |
| 31 | 40 | 3.99 | 25.1 | 3.41 | 32.5 | 132 |
| 32 | 87 | 4.01 | 25.1 | 3.39 | 32.5 | 139 |
| 33 | 170 | 3.99 | 24.9 | 3.61 | 32.5 | 144 |
| 34 | 300 | 4.00 | 24.7 | 3.8 | 32.5 | 152 |
| 35 | 400 | 4.00 | 24.7 | 3.8 | 32.5 | 151 |
| 36 | 1200 | 4.00 | 24.6 | 3.9 | 32.5 | 145 |
| 37 (V) | 0 | A: 0.54 | 25.44 | 6.52 | 32.5 | 87 |

TABLE 2.2
Gypsum paste experiments:

| Stock | | Solids content | Quantity | | |
|---|---|---|---|---|---|
| solution | PCE | (%) | (g) | Water (g) | 1N NaOH (g) |
| S3 | A | 40.1 | 10.02 | 10.061 | 50.09 |

| | Hydrolysis | Quantity | 0.1N | | | |
|---|---|---|---|---|---|---|
| | 22° C. | of | HCl | Water | Total | Slump |
| Sample | [min] | S3 (g) | (g) | (g) | (g) | (mm) |
| 38 | 3 | 8.02 | 52.3 | 76.08 | 136.4 | 165 |
| 39 | 20 | 8.01 | 51.7 | 76.69 | 136.4 | 171 |
| 40 | 40 | 8.00 | 51.2 | 77.20 | 136.4 | 178 |
| 41 | 60 | 8.02 | 51.2 | 77.18 | 136.4 | 180 |
| 42 | 140 | 8.03 | 50.7 | 77.67 | 136.4 | 183 |
| 43 | 200 | 8.02 | 50.4 | 77.98 | 136.4 | 185 |
| 44 | 1600 | 8.02 | 49.6 | 78.56 | 136.4 | 164 |
| 45 (V) | 0 | A: 1.13 | 51.20 | 86.33 | 136.4 | 163 |

The results show that the flowability of the cement and gypsum compositions can be adjusted over the duration of the hydrolysis treatment. With a series of experiments according to the invention, an optimal flow behavior can be determined. The graphical representation in FIG. 1 shows that in the exemplary cement paste experiment a high flow can be achieved in an optimal range if neither too few nor too many side chains are cleaved.

1. A method for producing an additive for a hydraulically setting composition, the method comprising:
providing a first aqueous solution comprising at least one comb polymer comprising a base polymer and side chains, and
cleaving at least a portion of the side chains of the comb polymer to form a second aqueous solution which is the additive.

2. The method according to claim 1, wherein cleavage of the side chains results in the adjustment of at least one property of a hydraulically setting composition containing the additive.

3. The method of claim 1 wherein the second solution is configured for addition to a hydraulically setting composition without separation into components.

4. A method for selecting an additive for a hydraulically setting composition, comprising the following steps:
producing an additive according to the method of claim 1,
mixing the additive with a hydraulically setting binder,
setting the hydraulically setting composition by mixing with water,
determining at least one property of the hydraulically setting composition, and
comparing the property with the same property of at least one additional hydraulically setting composition containing a corresponding additive in which the cleavage of the side chains took place to a different extent.

5. The method of claim 1, wherein the additive is for application in a construction application.

6. The method of claim 1, wherein the base polymer is a polycarboxylic acid.

7. The method of claim 6, wherein the side chains are linked to the polycarboxylic acid via ester groups, wherein at least some of the side chains comprise polyether groups.

8. The method of claim 1, wherein the comb polymer comprises:
at least one acrylic acid unit or a salt thereof and/or at least one methacrylic acid unit or a salt thereof; and
at least one structural unit of formula (I); 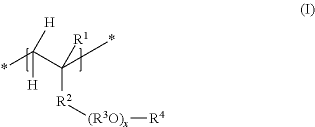
wherein:
R¹ independently of one another represents H or CH₃;
R² independently of one another represents an ester group —CO—O— or an amide group —CO—NH—,
R³ independently of one another represents a C₂-C₆ alkylene group,
R⁴ independently of one another represents H, a C₁-C₁₂ alkyl or cycloalkyl radical, a C₇-C₂₀ alkylaryl or aralkyl radical or a substituted or unsubstituted aryl radical, or a monovalent organic radical having 1 to 30 C atoms, which optionally includes hetero atoms, and
x independently of one another is a value from 0 to 250.

9. The method of claim 6, wherein the comb polymer before cleaving of the side chains has a side chain content and/or a degree of esterification of the base polymer from 20% to 99% based on the carboxy groups of the base polymer.

10. The method of claim 1, wherein between 5% and 95% of the side chains of the comb polymer are cleaved.

11-14. (canceled)

15. A kit for producing an additive for a hydraulically setting composition, wherein the kit comprises an aqueous solution of a comb polymer, the comb polymer comprising a base polymer and side chains, and an alkaline material for cleaving at least some of the side chains of the comb polymer.

16. The method of claim 1, wherein the second aqueous solution is a plasticizer for the hydraulically setting composition.

17. The method of claim 6, wherein the polycarboxylic acid is a polyacrylic acid, a polymethacrylic acid, or a co-polymer of acrylic acid and methacrylic acid.

18. The method of claim 8, wherein R³ independently of one another represents ethylene or propylene.

19. The method of claim 8, wherein x independently of one another is a value from 3 to 200.

20. The method of claim 6, wherein the comb polymer, prior to cleaving of at least some of the side chains, has a side chain content and/or a degree of esterification of the base polymer from 30% to 95%, based on carboxy groups of the base polymer.

21. The method of claim 1, wherein the cleaving comprises alkaline hydrolysis of ester groups.

22. The method of claim 1, wherein the first aqueous solution containing at least one comb polymer and the second aqueous solution have different setting behaviors.

23. A method comprising adding an aqueous solution to a hydraulically setting composition, wherein the aqueous solution comprises a side chain cleaved comb polymer.

24. The method of claim 23, wherein the aqueous solution comprising a side chain cleaved comb polymer is produced by providing an aqueous solution of a comb polymer, the comb polymer comprising a base polymer and side chains, and cleaving at least some of the side chains to form the aqueous solution, wherein the aqueous solution is added to the hydraulically setting composition without separation into components.
